(19) United States
(12) Patent Application Publication
(10) Pub. No.: US 2025/0081986 A1
(43) Pub. Date: Mar. 13, 2025

(54) Canola Protein Concentrate and Process for Production

(71) Applicant: Louis Dreyfus Company Plant Proteins LLC, Livermore, CA (US)

(72) Inventors: Prasanth Kumar Sasidharan Pillai, Livermore, CA (US); Manoj Kumar, Livermore, CA (US)

(21) Appl. No.: 18/792,399

(22) Filed: Aug. 1, 2024

Related U.S. Application Data
(60) Provisional application No. 63/532,309, filed on Aug. 11, 2023.

(51) Int. Cl. A23J 1/14; A23L 25/00; A23L 27/60

(52) U.S. Cl. CPC A23J 1/144; A23L 25/30; A23L 27/60

(57) ABSTRACT

Provided herein are a processes for producing a canola protein concentrate (CPC) from de-oiled canola flour that is economical and produces canola protein concentrate that has unique composition and functionality.

### CROSS-REFERENCE

This application claims benefit of U.S. Provisional Patent Application No. 63/532,309 filed Aug. 11, 2023, which application is incorporated herein by reference in its entirety.

### BACKGROUND OF THE INVENTION

Oil seeds, such as canola, are an emerging a source of proteins for culinary applications. Recent trends toward the use of vegetable proteins to replace animal-derived protein has created a significant demand for the production of plant protein products with unique and desirable qualities, particularly for use in foods meant to replace animal-based products. Seed-derived proteins have become a coveted source for producing nutritionally-enhanced products and meat and dairy substitutes with preferred textural appeal and varied functionalities. Therefore, protein concentrates from seeds that are both economical and have desirable physical properties for use in plant-based foods and products are in great demand.

The production of protein concentrate from canola seed has been actively pursued for several decades. U.S. Pat. No. 6,992,173 describes production of canola seed protein isolate from desolvented canola meal through a selective membrane technique and controlling ionic strength, as does U.S. Pat. No. 7,687,087. Various other procedure involving selective membrane techniques and/or diafiltration are described in U.S. Pat. Nos. 8,580,330, 9, 115,202, 11,013,243 and U.S. published application No. 2012-20269948A1. Other disclosures employ heat to provide canola protein isolates, including U.S. Pat. Nos. 7,955,625, 7,959,968, 8,021,703 and 8,999,426. Production of novel canola protein compositions with unique functionality by procedures that are technologically and economically viable are in constant demand.

### SUMMARY OF THE INVENTION

The present invention provides a process for producing a canola protein concentrate (CPC) from de-oiled canola flour that is economical and produces canola protein concentrate that has unique composition and functionality. The process involves use of low temperatures below where denaturation of proteins occurs to produce a canola protein product with a protein content 45-70 wt % (N×6.25) on a dry basis while maintaining the native form of the proteins in the concentrate. The process also does not require membrane filter-based separation. The canola protein concentrate has highly desirable foaming, gelation and emulsion attributes, making it applicable to many plant-based food and beverage uses.

In one aspect of the invention, a process is provided for extracting a canola protein concentrate comprising, stepwise, extracting in 30-70% ethanol in water (by volume) de-oiled, desolvated canola seed flour having <3% oil, the extraction performed at a maintained temperature of 30-62° C. and a pH range of 4-6, then removing the ethanol from the canola protein concentrate and water, dilutubg the concentrate with water to create a slurry and homogenizing and drying the canola seed protein concentrate to a moisture range of 4-10%. In some embodiments, the alcohol extraction is performed in a Nutsche filter. In certain embodiments, the de-oiled, desolvated canola seed flour is a fine power fraction of the de-oiled, desolvated canola seed flour, wherein the hulls have been removed. In some embodiments, the fine powder fraction consists essentially of particles of ≤500 μm. In some embodiments, the fine powder fraction is obtained by sieving. In some embodiments, the fine powder fraction is obtained by air classification. In certain embodiments, the canola seed flour contains ≤1% oil. In some embodiments, the protein content of the de-oiled, desolvated canola seed flour is 45-70% protein (N×6.25), on a dry basis. In other embodiments, the canola seed flour is 45-53% protein (N×6.25), on a dry basis. In certain embodiments, the extraction step is carried out at 40-60° C. In some embodiments, the extraction step is carried out at pH 4-5. In certain embodiments, the extraction step is carried out for 15-30 minutes. In some embodiments, one or more of the alcohol extraction, solvent removal and washing of the canola protein concentrate are performed using a Nutsche filter.

In another aspect of the invention, a canola protein concentrate is provided. In certain embodiments, the canola protein concentrate produced by the above process is provided. In certain embodiments, the canola protein concentrate has a protein content of 55-73% by weight (N×6.25) on a dry basis. In certain embodiments, the canola protein concentrate comprises 5-20% oleosin. In some embodiments, the canola protein concentrate comprises 12-15% oleosin. In some embodiments, the canola protein concentrate comprises 50-65% cruciferin, 5-20% oleosin and 8-15% napin. In certain embodiments, the canola protein concentrate comprises 1-3% oil, ≤4% phytates, ≤40% carbohydrates, ≤1% polyphenol, ≤0.5% glucosinolates and ≤5% ash. In some embodiments, the protein in the canola protein concentrate is substantially maintained in its native form. In some embodiments, the canola seed protein concentrate has a foaming expansion capacity of 180-300% at a concentration of 4-5% by weight in water. In certain embodiments, the canola seed protein concentrate has a foaming stability of 50-80% at a concentration of 4-5% by weight in water after 1 hour. In certain embodiments, the canola protein concentrate has emulsion stability of 100% at a protein concentration ≥4% in equal parts oil and water after 5 days cold storage. In some embodiments, the canola seed protein concentrate has oil/water emulsion stability of 100% at a protein concentration ≥4% after 5 days cold storage, the emulsion made at a pH of 5-7. In certain embodiments, the canola protein concentrate has a least gelation concentration of 5-8% in water. In some embodiments, the canola protein concentrate has a water holding capacity of 4-10 grams per gram (g/g). In some embodiments, the canola protein concentrate has an oil holding capacity of 3-9 g/g.

In a different aspect of the invention, a foam comprising the canola seed protein concentrates described above is provided.

In another aspect of the invention, a gel comprising the canola seed protein concentrates described above is provided.

In yet another embodiment, an emulsion comprising the canola seed protein concentrates described above is provided.

In a different aspect of the invention, use of the canola seed protein concentrates described above in the production of a foam is provided. In another aspect of the invention, use of the canola seed protein concentrates described above in the production of a gel is provided. In yet another aspect of the invention, use of the canola seed protein concentrates described above in the production of an emulsion is provided. In some embodiments, the emulsion is an oil/water emulsion.

In a different aspect of the invention, use of the canola seed protein concentrates described above in a food or beverage application is provided. In some embodiments, the food or beverage application is selected from milk shake, protein bars, meat analogues, confectionary, mayonnaise, salad dressing, nutritional supplements and dairy alternatives. In certain embodiments, the dairy alternative is selected from creamers, ice cream, yogurt, buttermilk and cheese.

In yet a different aspect, a food or beverage comprising the canola protein concentrates described above is provided.

### BRIEF DESCRIPTION OF THE DRAWINGS

FIGS. 1A-C shows canola seeds, flaked canola seed flour and de-oil, desolvented flaked canola seed flour, respectively.

FIG. 2A shows the hexane with extracted oil after each of 6 rounds of extraction of canola seed oil from flakes canola seed flour.

FIG. 2B shows the Brix refractive index (Brix RI) for hexane (at point 0) and for each of the 6 extraction cycles in the canola seed oil extraction process described in Example 1.

FIG. 3A-3C shows de-oiled canola flour, canola flour sieved using a 300-450 μm screen and even finer fractions of canola flour, respectively.

FIG. 4 shows CPC produced using the canola seed protein extraction process described herein.

FIG. 5 shows differential scanning calorimetry performed on the CPC produced using the canola seed protein concentrate extraction process disclosed herein.

FIG. 6 shows an SDS-PAGE analysis of CPC, showing the presence of cruciferin, oleosin and napin.

FIG. 7 shows an example of a gel produced using the CPC of the invention.

FIG. 8A-8B shows examples foaming expansion capacity and foaming stability of the CPC of the invention, respectively.

FIGS. 9A-9B shows emulsion made from CPC at pH 5 and pH 7, respectively.

FIG. 10 shows the mayonnaise-like texture of a CPC emulsion.

### DETAILED DESCRIPTION OF THE INVENTION

Processes are provided for the production of a protein concentrate from de-oil, desolvented canola seed flour, as well as canola seed concentrate compositions, compositions comprising canola seed protein concentrates and uses for such canola seed protein concentrates. The processes involve the extraction of de-oiled, desolvented canola seed flour with 30-70% ethanol in water at low temperatures and not requiring membrane filtration-based separation. The canola seed protein concentrate is amenable to further uses in the form of foams, gels and emulsions and in various food and beverage applications.

Before the present processes, compositions and uses are described, it is to be understood that this invention is not limited to the particular methods or compositions described, which may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed within the invention. The upper and lower limits of these smaller ranges may independently be included or excluded in the range, and each range where either, neither or both limits are included in the smaller ranges is also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, some potential and preferred methods and materials are now described. All publications mentioned herein are incorporated herein by reference to disclose and describe the methods and/or materials in connection with which the publications are cited. It is understood that the present disclosure supersedes any disclosure of an incorporated publication to the extent there is a contradiction.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

It must be noted that as used herein and in the appended claims, the singular forms “a”, “an”, and “the” include plural referents unless the context clearly dictates otherwise.

The publications discussed herein are provided solely for their disclosure prior to the filing date of the present application. Nothing herein is to be construed as an admission that the present invention is not entitled to antedate such publication by virtue of prior invention. Further, the dates of publication provided may be different from the actual publication dates which may need to be independently confirmed.

### Definitions

The term “about”, particularly in reference to a given quantity, is meant to encompass deviations of plus or minus five percent.

“Extracting” or “extraction” means the removal or separation of one or more component(s) of a multicomponent composition.

“de-oiled canola seed flour” means canola seed flour (also referred to as canola flour) from which 97-≥99% of the oil has been removed through an oil extraction process. In some instances, the oil content of the de-oiled canola flour is ≤3%. Such a process is described in a concurrently filed patent application.

“Desolventing” means the removal of residual solvent, such as hexane, from de-oiled seed flour. “Desolvented” means something that has gone through desolventing.

“Substantially in native form” in the context of proteins in in oil seed flour means that the proteins have not been denatured due to, for example, exposure to excessive heat, such that the 3-dimensional structure of the proteins are generally maintained in the form found in the pre-processed seed.

Extracting Canola Seed Protein Concentrate from Canola Flour

Processes are provided for the production of canola seed protein concentrates from de-oil, desolvented canola flour. A process for de-oiling and desolventing is disclosed in concurrently filed U.S. patent application Ser. No. 18/792,381, incorporated herein by this reference. A brief description of the de-oiling and desolventing process is described in Example 1. Other means of providing de-oiled desolvented canola seed flour are known in the art.

In a preferred embodiment of the present processes, fine grains of de-oiled, desolvented canola flour are separated from larger, courser grains to produce a fine powder canola flour. The fine powder canola flour will functionally have the hulls removed and the protein content will be higher. The fine powder canola flour will typically consist essentially of particles <500 μm. The fine powder canola seed flour will generally have a higher protein content than the original canola seed flour, typically >50%, although the range is typically 48-53% protein by weight (N×6.25), dry basis. This separation may be done by any of a number of means known in the art. Methods for removing hulls and separating fine from large particles include sieving, air classification, or a combination of these. For example, sieving using a 300-450 μm screen is effective to give a fine powder canola flour.

The de-oiled, desolvented canola seed flour is subjected to extraction by placing the canola flour in a solution of 30-70% (volume to volume) alcohol at a range of pH 4 to pH 6 and at a temperature of about 30-62° C. While ethanol is typically used, other alcohols, such as isopropanol, 1-propanol and 2-propanol may also be used. In some embodiments the pH range of the ethanol solution is narrower, such as pH 4 to pH 5. In some embodiments, the temperature range is narrower, in the range of about 40-60° C. It is important to keep the temperature below that which causes denaturation of proteins in the canola flour. Therefore, use of temperatures exceeding about 60° C. for any significant amount of time is contrary to the current invention. Generally, temperature is kept at or below about 60° C. throughout the canola protein concentrate process. Typically the alcohol extraction is performed for 30-60 minutes. In certain embodiments, the alcohol extraction process is carried out in a Nutsche filter.

The alcohol is then removed from the extracted canola flour, now canola protein concentrate, and water. Means for removing alcohol, such as ethanol, from a wet powder are well known in the art. Any of a number of commercially available desolventizers may be used. Any method or combination of methods of removing the alcohol may be employed, and the determination of a proper method of separating a liquid fraction from the solids is well within the skill of the ordinary artisan. In certain embodiments, the temperature of the canola protein concentrate is kept below about 60° C. during alcohol removal.

After removal of the alcohol from the canola protein concentrate and water, the canola concentrate is dried by standard means generally known to the skilled artisan, typically to a moisture level of 4-10%. In certain embodiments, the temperature of the canola protein concentrate is kept below about 60° C. during drying. The canola protein concentrate may then be used in various applications, as further described below.

In a different embodiment, after the alcohol removal, the extracted protein is separated by decanting and/or centrifuging, and optionally may get subsequent washes with water at precipitation pH (e.g., pH 4-5). The separated protein is then diluted with water adjusted to about pH 7, creating a protein slurry. The protein slurry is homogenized by means known in the art. For example, a high pressure homogenizer may be used. The homogenized protein slurry is then optionally sterilized and/or pasteurized. This is the only time at which the extracted protein is subjected to temperatures above about 60° C. Means for sterilizing protein for use in foods are known in the art. An example of such a means is direct steam injection. The protein slurry may be subjected to direct steam injection for between 2 seconds and 10 minutes.

The protein concentrate is then dried by standard means using a drying apparatus known in the art, typically to a moisture level of 4-10%. Several apparatuses that may be used for drying, such as spray dryer, ring dryer, dispersion dryer, drum dryer, fluid bed dryer, are commercially available. The resulting canola seed protein concentrate may then be used as further described below.

### Canola Seed Protein Concentrates

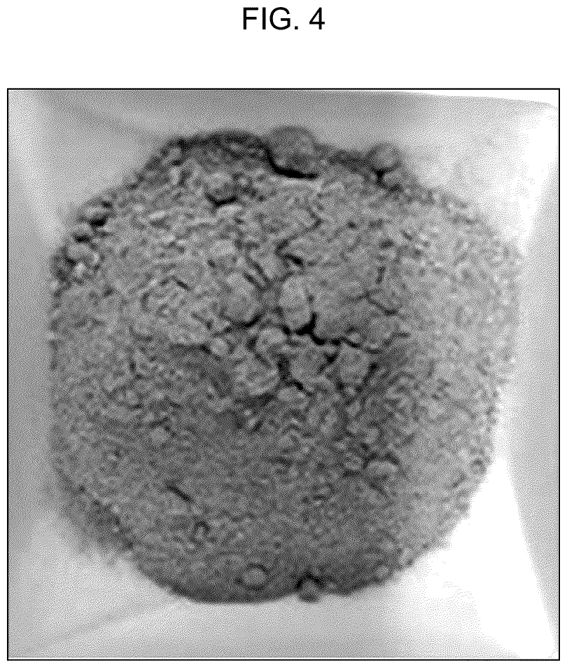

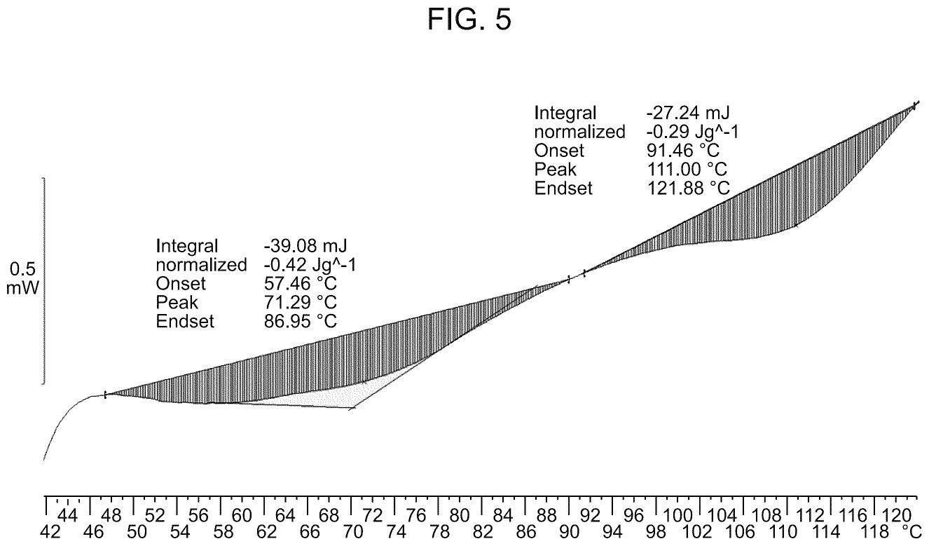

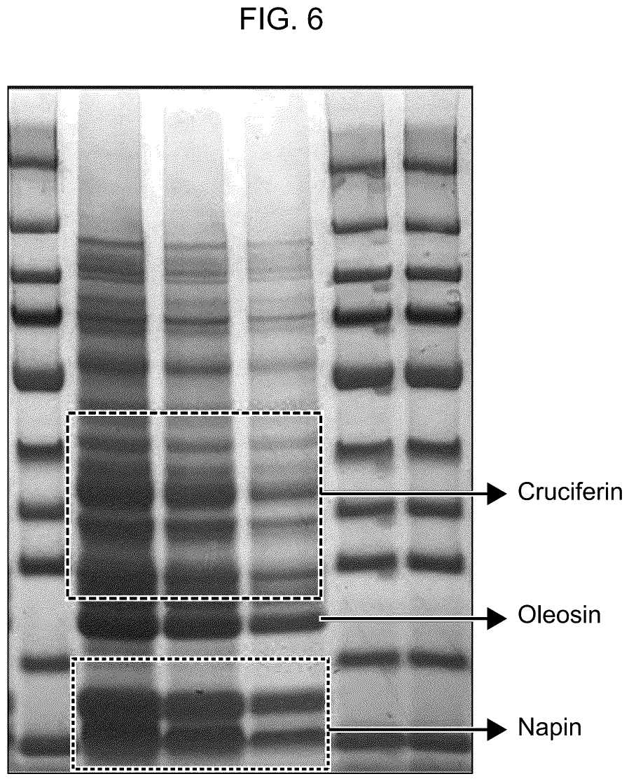

In addition to the production of canola protein concentrate (CPC), the present invention provides canola protein concentrates, including CPCs produced by such processes, having particular useful characteristics. FIG. 4 shows an example of The CPC produced by the above process having protein content of 55-73% by weight on a dry basis, calculated using the Kjedahl method (N×6.25). The process allows for the protein in the CPC to maintain its native form (FIG. 4). In addition to the expected components of cruciferin and napin, found in other described canola protein concentrates, the protein of the present CPC contains oleosin, making up 5-20% of the protein in the CPC. In some embodiments, the oleosin content ranges from 12-15% of the protein. The protein component of the CPC produced using the present protein concentrate extraction process contains 50-65% cruciferin and 8-15% napin. (see FIG. 6) In addition, the CPC typically contains ≤1-3% fat (including oil), ≥4% phytates, ≤40% carbohydrates, <5% ash, ≤1% polyphenol and ≤0.5% glucosinolates. The protein in the CPC of the present invention is in its substantially native form. FIG. 5 shows a differential scanning thermogram of CPC produced using the present process. The thermogram shows exothermic events at about 71° C. and 111° C., corresponding to the denaturation of napin and cruciferin, respectively.

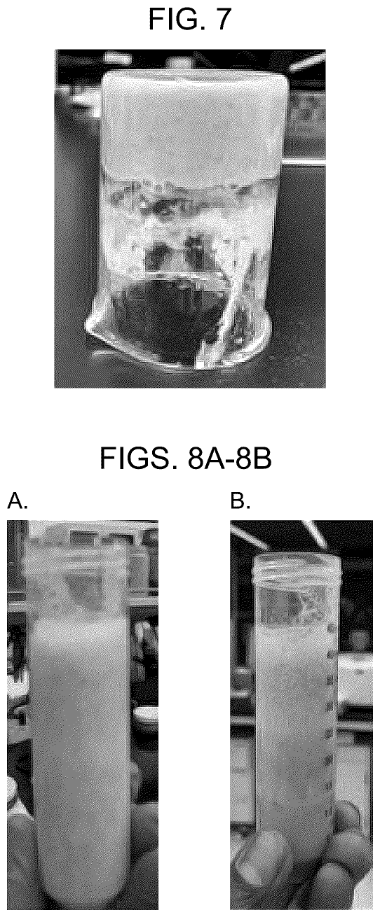

The CPC of the present invention has several attributes that make it especially useful in the plant-based food industry. For example, the CPC is capable of gelling in water at a concentration of ≥5-8% (least gelling concentration). FIG. 7 shows examples of gelled CPC in water at a concentration of 5-8%, where the gelling was produced by heating to 95° C. followed by cooling to 5° C.

Additionally, the CPC has foaming expansion capacity of 180-300% at a concentration of ≥4-5%, weight to weight, in water. In addition, the CPC at a concentration of 4-5% in water has foaming stability of 50-80% after 1 hour. FIG. 8A shows an example of 250-300% foaming expansion of 5% (w/w) CPC in water. FIG. 8B shows an example of 75-80% foaming stability of 5% (w/w) CPC in water.

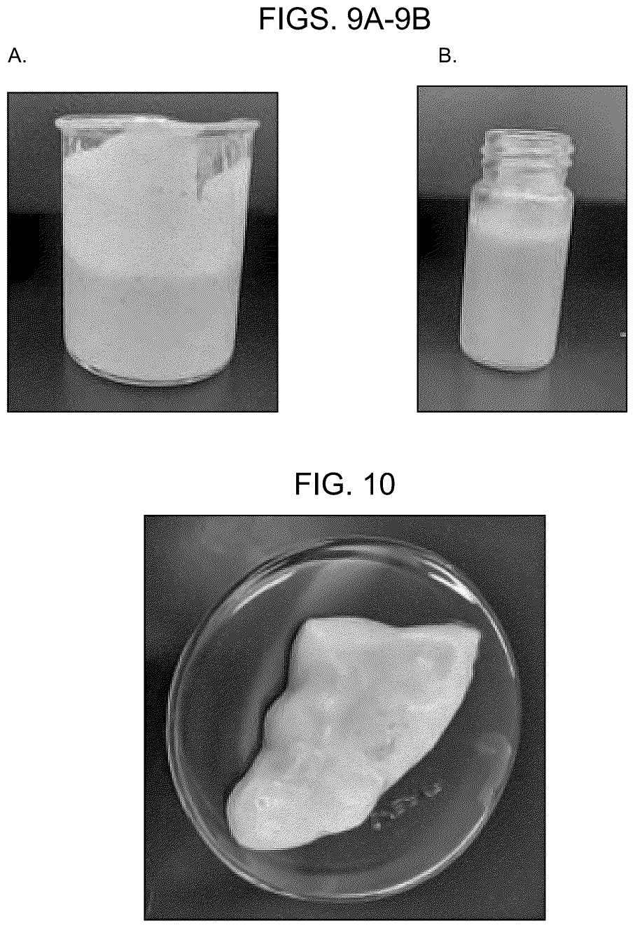

The CPC also has the capacity to form an emulsion in a 1:1 mixture of water and oil at CPC concentration of ≥4%. At CPC concentrations of 4-5%, weight to weight, in a water and oil 1:1 mixture, volume to volume, emulsions maintained 100% after 5 days in cold storage. FIGS. 9A and 9B show emulsion of 5% (w/w) CPC in equal parts water and oil, produced at pH 5 and pH 7, respectively. FIG. 10 depicts the mayonnaise-like texture of the CPC-based emulsion.

The gelling, foaming and emulsification attribute of the CPC of the present invention provide for various plant-based food applications, as further described below.

### Uses of Canola Protein Concentrates

The canola protein concentrates have a variety of uses, particularly in plant-based food and beverage applications. The CPC of the present invention finds use in, for example, milk shakes, protein bars, meat analogues, confectionary, condiments, mayonnaise, salad dressing nutritional supplements and dairy alternatives such as creamer, ice cream, yogurt, buttermilk and cheese. These are no-limiting examples of food and beverages comprising CPC of the present invention.

### Exemplary Non-Limiting Aspects of the Disclosure

Aspects, including embodiments, of the present subject matter described above may be beneficial alone or in combination, with one or more other aspects or embodiments. Without limiting the foregoing description, certain non-limiting aspects of the disclosure numbered 1-43 are provided below. As will be apparent to those of skill in the art upon reading this disclosure, each of the individually numbered aspects may be used or combined with any of the preceding or following individually numbered aspects. This is intended to provide support for all such combinations of aspects and is not limited to combinations of aspects explicitly provided below:
1. A canola protein concentrate process comprising:
   a. extracting in 30-70% ethanol in water (by volume) de-oiled, desolvated canola seed flour, said canola seed flour having ≤3% oil, the extraction comprising the parameters of:
      i) a maintained temperature of 30-62° C.,
      ii) a pH range of pH 4-6.
   b. removing the ethanol from the canola seed protein-concentrate and water,
   c. optionally washing the canola protein concentrate with water at pH 4-5, then diluting the sunflower protein concentrate with water at pH 7 to create a slurry, then homogenizing said slurry,
   d. optionally sterilizing and/or pasteurizing the wet canola protein concentrate, and
   e. drying the wet canola flour protein concentrate to a moisture range of 4-10%.
2. The process of Aspect 1, wherein the alcohol extraction is performed in a Nutsche filter.
3. The process of any of Aspects 1-2, wherein the de-oiled, desolvated canola seed flour is a fine powder fraction (hulls separated and removed) of de-oiled, desolvated canola seed flour.
4. The process of Aspect 3, wherein the fine powder fraction consists essentially of particles of ≤500 μm.
5. The process of any of Aspects 3-4, wherein the fine powder fraction is obtained by sieving.
6. The process of any of Aspects 3-4, wherein the fine powder fraction is obtained by air classification.
7. The process of any of Aspects 1-6, wherein the protein content of the de-oiled, desolvated canola seed is 45-70 wt % protein (N×6.25) on a dry basis.
8. The process of any of Aspects 1-7, wherein the protein content of the de-oiled, desolvated canola seed is 48-53 wt % protein (N×6.25) on a dry basis.
9. The process of any of Aspects 1-8, wherein the de-oiled, desolvated canola seed flour contains <1% oil.
10. The process of any of Aspects 1-9, wherein steps a. is carried out at 40-60° C.
11. The process of any of Aspects 1-10, wherein step a. is carried out at pH 4-5.
12. The process of any of Aspects 1-11, wherein step a. is carried out for 15-30 minutes.
13. The process of any of Aspects 1-12, wherein step e. is performed using spray dryer, ring dryer, dispersion dryer, drum dryer or fluid bed dryer.
14. The process of any of Aspects 1-13, wherein steps b., c. and e. are carried out at about ≤60° C.
15. A canola protein concentrate produced by the process of any of Aspects 1-14.
16. The canola protein concentrate of Aspect 15 having a protein content of 55-73% protein by weight (N×6.25) on a dry basis.
17. The canola protein concentrate of any of Aspects 15-16, wherein the protein component of the canola protein concentrate comprises 5-20% oleosin.
18. The canola protein concentrate of any of Aspects 15-17 wherein the protein component of the canola protein concentrate comprises:
   a. 50-65% cruciferin,
   b. 5-20% oleosin and
   c. 8-15% napin.
19. The canola protein concentrate of Aspect 18, further comprising:
   d. 1-3% oil,
   e. ≤4% phytates,
   f. ≤40% carbohydrates,
   g. ≤1% polyphenol,
   h. ≤0.5% glucosinolates, and
   i. ≤5% ash.
20. The canola protein concentrate of Any of Aspects 15-19, wherein the protein is substantially in native form.
21. A canola protein concentrate, wherein the protein component of the canola protein concentrate comprises 5-20% oleosin.
22. The canola protein concentrate of Aspect 21, wherein the protein component of the canola protein concentrate comprising 12-15% oleosin.
23. The canola protein concentrate of any of Aspects 21-22, wherein the protein component of the canola protein concentrate comprises:
   a. 50-65% cruciferin,
   b. 5-20% oleosin, and
   c. 8-15% napin.
24. The canola protein concentrate of any of Aspects 21-23, comprising 55-73% protein by weight (N×6.25) on a dry basis.
25. The canola protein concentrate of Any of Aspects 21-24, wherein the protein is substantially in native form.
26. The canola protein concentrate of Any of Aspects 15-25 having a foaming expansion capacity of 180-300% at 4-5% (w/w) canola protein concentrate in water.
27. The canola protein concentrate of Any of Aspects 15-26 having a foaming stability of 50-80% at 4-5% (w/w) canola protein concentrate in water after 1 hour.
28. The canola protein concentrate of Any of Aspects 15-27 having an emulsion stability of 100% at ≥4% (w/w) canola protein concentrate in oil/water (50/50) after 5 days cold storage.
29. The canola protein concentrate of Aspect 28, wherein the emulsion is prepared at pH 5-7.
30. The canola protein concentrate of any of Aspects 15-29 having a least gelation concentration of 5-8%.
31. The canola protein concentrate of any of Aspects 15-30 having a water holding capacity of 4-10 grams per gram (g/g).
32. The canola protein concentrate of any of Aspects 15-31 having an oil holding capacity of 3-9 grams per gram (g/g).
33. Use of the canola protein concentrate of any of Aspects 15-32 in the production of a foam.
34. Use of the canola protein concentrate of any of Aspects 15-32 in the production of a gel.
35. Use of the canola protein concentrate of any of Aspects 15-32 in the production of an emulsion.
36 The use of Aspect 35, wherein the emulsion is an oil/water emulsion.
37. A foam comprising the canola protein concentrate of any of Aspects 15-32.
38. A gel comprising the canola protein concentrate of any of Aspects 15-32.
39. An emulsion comprising the canola protein concentrate of any of Aspects 15-32.
40. Use of the canola protein concentrate of any of Aspects 15-32 in a food or beverage application.
41. The use of Aspect 40, wherein the food or beverage application is selected from milk shake, protein bars, meat analogues, confectionary, condiments, mayonnaise, salad dressing, nutritional supplements and diary alternatives.
42. The use of Aspect 41, wherein the dairy alternative is selected from creamers, ice cream, yogurt, buttermilk and cheese.
43. A food or beverage comprising the canola seed protein concentrate of any of Aspects 15-32.

### EXAMPLES

The following examples are put forth so as to provide those of ordinary skill in the art with a complete disclosure and description of how to make and use the present invention, and are not intended to limit the scope of what the inventors regard as their invention nor are they intended to represent that the experiments below are all or the only experiments performed. Efforts have been made to ensure accuracy with respect to numbers used (e.g., amounts, temperature, etc.) but some experimental errors and deviations should be accounted for. Unless indicated otherwise, parts are parts by weight, temperature is in degrees Centigrade, and times are in minutes.

All publications and patent applications cited in this specification are herein incorporated by reference as if each individual publication or patent application were specifically and individually indicated to be incorporated by reference.

The present invention has been described in terms of particular embodiments found or proposed by the present inventor to comprise preferred modes for the practice of the invention. It will be appreciated by those of skill in the art that, in light of the present disclosure, numerous modifications and changes can be made in the particular embodiments exemplified without departing from the intended scope of the invention. All such modifications are intended to be included within the scope of the appended claims.

### Example 1: Extraction of Canola Seed Oil from Canola Flour

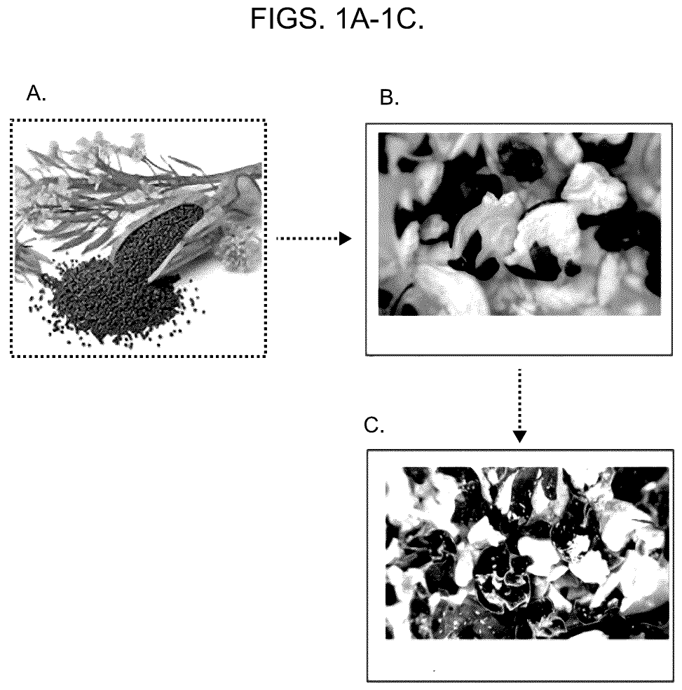

Canola oil seeds were flaked at a low temperature <50° C. FIG. 1 pictures canola seeds, flaked canola seed flour and de-oiled flaked canola seed flour in Figures A, B and C, respectively.

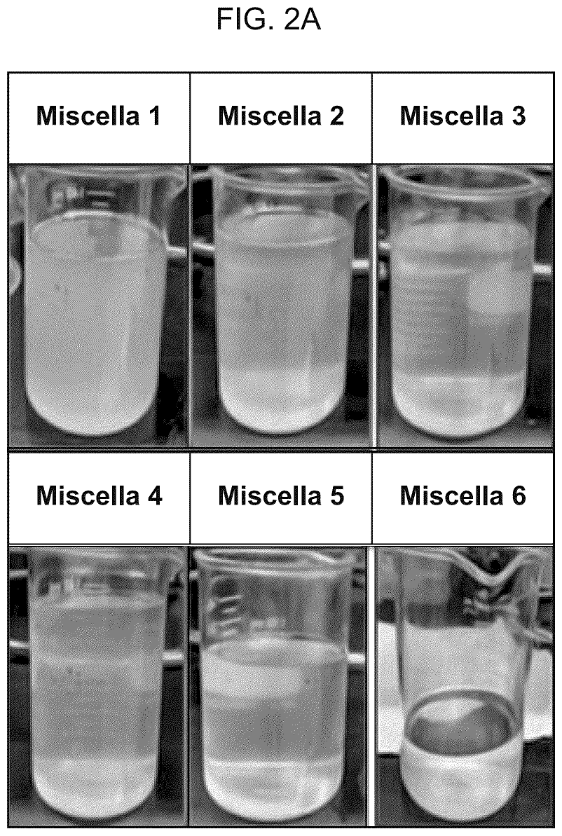

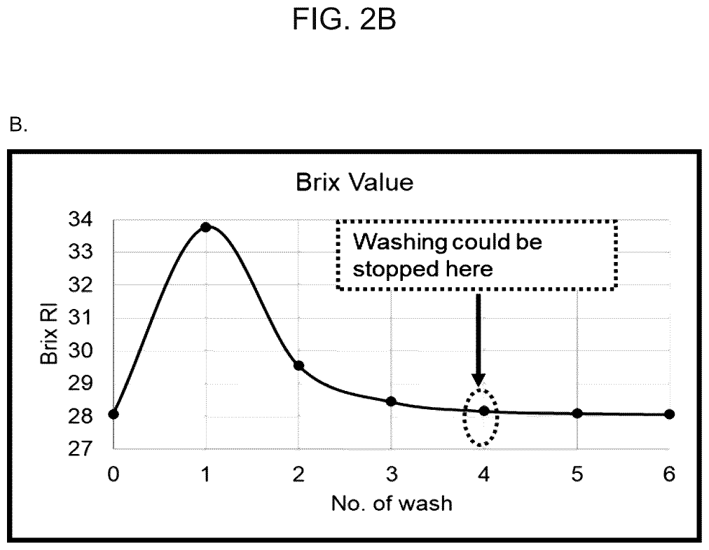

Oil was extracted from the flaked canola seeds using a Nutsche Filter (NF). The flaked canola seed flour was mixed with hexane in a ratio of 1:2 (w:v) and 6 cycles of extraction were performed at a maintained temperature of 50° C.; each extraction lasted 45 minutes. FIG. 2A shows the hexane with extracted oil after each of 6 rounds of extraction.

FIG. 2B shows the Brix refractive index (Brix RI) for hexane (at point 0) and for each of the 6 extraction cycles. Based on the refractive index returning essentially to baseline after cycle 4, it was determined that oil separation ≥97% could be obtained in a minimum of 4 cycles.

### Example 2: Extraction of Canola Seed Protein Concentrate

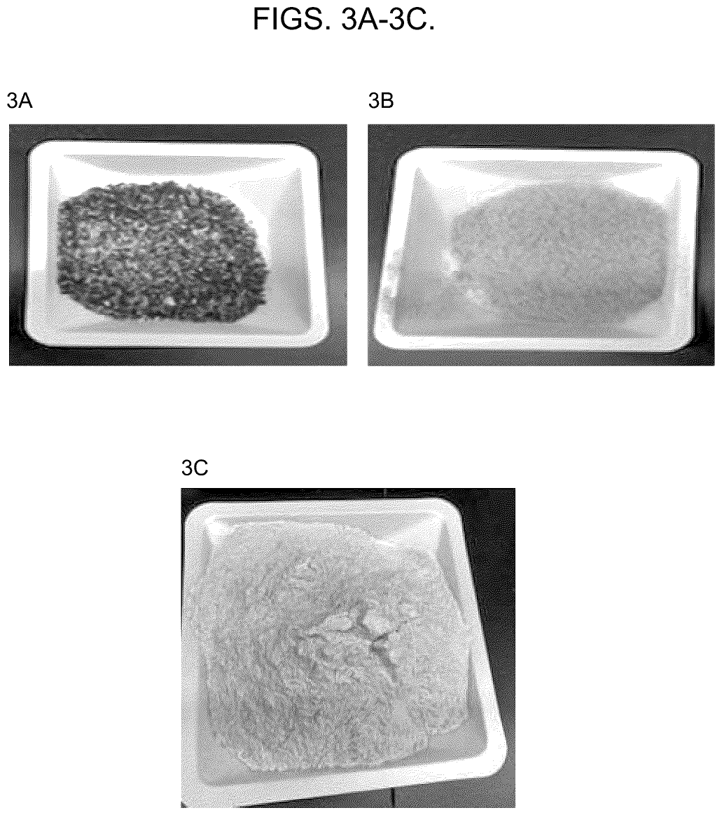

De-oiled, desolvented canola seed was dehulled by sieving via a 300-450 μm screen. FIGS. 3A, 3B and 3C show separated seed hulls, fine dehulled canola flour having 50-51% protein content (N×6.25) on a dry basis and finer fractions of canola flour having 52-53% protein content (N×6.25) on a dry basis, respectively. The resulting flour was placed in a 30-70% ethanol in water solution at pH 4-5 and a temperature of 50-60° C. for 15-30 minutes. The solvent was then removed from the canola flour and water in a desolventizer, maintaining a temperature at or below 60° C. The extracted flour was then dried at a temperature at or below 60° C. to a moisture content of 4-10% to produce the canola protein concentrate. FIG. 4 shows dried canola protein concentrate.

### Example 3: Maintained Integrity of Native Protein Form in Canola Protein Concentrate

Differential scanning calorimetry was performed on the resulting CPC (FIG. 5), showing a thermal transition profile with exothermal events occurring at about 71 and 111° C., corresponding to denaturation of cruciferin and napin, respectively. This confirms that the protein in the CPC is substantially in its native form.

### Example 4: Protein Composition of CPC

CPC produced using the extraction process taught herein was analyzed by SDS-PAGE, which separated proteins in a sample by their molecular weight. FIG. 6 shows an SDS-PAGE analysis of CPC, showing the presence of cruciferin, oleosin and napin. For the protein fraction of the CPC sample, cruciferin made up 50-65%, oleosin made up 12-15% and napin made up 8-12%.

### Example 5: Gelling Capacity of CPC

Least gelation concentration (LGC) was determined for one batch of CPC produced as described herein. LGC was determined using various concentrations of CPC in water. The mixture was heated to 95° C., then cooled to 5° C. The LGC for this batch was determined to be 5-8%. A sample gel produced are shown in FIG. 7.

### Example 6: Foaming Capacity of CPC

Foams were made with 20 ml of a 5% CPC solution in water. Foams were made using an homogenizer at 10000 rpm for 5 minutes. Foaming expansion capacity (% FE) was calculated using the equation % FE=Vfo/Vli×100, where Vfo is foam volume and Vli is the volume of the liquid before foaming. FIG. 8A shows an example of a foam made from 5% CPC in water showing foaming expansion of 250-300%. The CPC displayed a foaming expansion capacity of 180-300%.

Foaming stability (% FS) was determined using the equation % FS=[(Vli−Vlt)/(Vli−Vlo)], where Vlt is the liquid volume after 60 minutes, and Vlo is the volume of liquid immediately after foaming. FIG. 8B shows an example of a foam made from 5% CPC in water showing foaming stability of 75-80% after 1 hour. The CPC displayed a foaming stability of 50-95% after 60 minutes.

### Example 7: Emulsion Capacity of CPC

Emulsions using varied concentrations of CPC (0.5-5%) in a mixture of equal parts oil and water were made using a homogenizer at 8000 rpm for 3 minutes. The emulsions displayed 100% stability after 5 days cold storage. FIGS. 9A and 9B show examples of emulsions made with CPC at pH 5 and pH 7, respectively. FIG. 10 show the mayonnaise-like quality of the CPC emulsion.

1. A canola protein concentrate process comprising:
a. extracting, in a Nutsche filter, in 30-70% ethanol in water (by volume) de-oiled, desolvated canola seed flour, said canola seed flour having ≤3% oil, the extraction comprising the parameters of:
i) a maintained temperature of 30-62° C.,
ii) a pH range of pH 4-6,
b. removing the ethanol from the canola seed protein-concentrate and water,
c. optionally washing the canola protein concentrate with water at pH 4-5, then diluting the sunflower protein concentrate with water at pH 7 to create a slurry, then homogenizing said slurry,
d. optionally sterilizing and/or pasteurizing the wet canola protein concentrate, and
e. drying the wet canola flour protein concentrate to a moisture range of 4-10%.

2. (canceled)

3. The process of claim 1, wherein the de-oiled, desolvated canola seed flour is a fine powder fraction (hulls separated and removed) of de-oiled, desolvated canola seed flour.

4. The process of claim 3, wherein the fine powder fraction consists essentially of particles of ≤500 μm.

5. The process of claim 3, wherein the fine powder fraction is obtained by sieving.

6. The process of claim 3, wherein the fine powder fraction is obtained by air classification.

7. The process of claim 1, wherein the protein content of the de-oiled, desolvated canola seed is 45-70 wt % protein (N×6.25) on a dry basis.

8. The process of claim 1, wherein the protein content of the de-oiled, desolvated canola seed is 48-53 wt % protein (N×6.25) on a dry basis.

9. The process of claim 1, wherein the de-oiled, desolvated canola seed flour contains <1% oil.

10. The process of claim 1, wherein steps a. is carried out at 40-60° C.

11. The process of claim 1, wherein step a. is carried out at pH 4-5.

12. The process of claim 1, wherein step a. is carried out for 15-30 minutes.

13. The process of claim 1, wherein step e. is performed using spray dryer, ring dryer, dispersion dryer, drum dryer or fluid bed dryer.

14. The process of claim 1, wherein steps b., c. and e. are carried out at about ≤60° C.

15. A canola protein concentrate produced by the process of claim 1.

16. The canola protein concentrate of claim 15 having a protein content of 55-73% protein by weight (N×6.25) on a dry basis.

17. The canola protein concentrate of claim 15, wherein the protein component of the canola protein concentrate comprises 5-20% oleosin.

18. The canola protein concentrate of claim 15 wherein the protein component of the canola protein concentrate comprises:
a. 50-65% cruciferin,
b. 5-20% oleosin, and
c. 8-15% napin.

19. The canola protein concentrate of claim 18, further comprising:
d. 1-3% oil,
e. ≤4% phytates,
f. ≤40% carbohydrates,
g. ≤1% polyphenol,
h. ≤0.5% glucosinolates, and
i. ≤5% ash.

20. The canola protein concentrate of claim 15, wherein the protein is substantially in native form.

21. A canola protein concentrate, wherein the protein component of the canola protein concentrate comprises 5-20% oleosin.

22. The canola protein concentrate of claim 21, wherein the protein component of the canola protein concentrate comprising 12-15% oleosin.

23. The canola protein concentrate of claim 21, wherein the protein component of the canola protein concentrate comprises:
a. 50-65% cruciferin,
b. 5-20% oleosin, and
c. 8-15% napin.

24. The canola protein concentrate of claim 21, comprising 55-73% protein by weight (N×6.25) on a dry basis.

25. The canola protein concentrate of claim 21, wherein the protein is substantially in native form.

26. The canola protein concentrate of claim 15 or 21 having a foaming expansion capacity of 180-300% at 4-5% (w/w) canola protein concentrate in water.

27. The canola protein concentrate of claim 15 or 21 having a foaming stability of 50-80% at 4-5% (w/w) canola protein concentrate in water after 1 hour.

28. The canola protein concentrate of claim 15 or 21 having an emulsion stability of 100% at ≥4% (w/w) canola protein concentrate in oil/water (50/50) after 5 days cold storage.

29. The canola protein concentrate of claim 28, wherein the emulsion is prepared at pH 5-7.

30. The canola protein concentrate of claim 15 or 21 having a least gelation concentration of 5-8%.

31. The canola protein concentrate of claim 15 or 21 having a water holding capacity of 4-10 grams per gram (g/g).

32. The canola protein concentrate of claim 15 or 21 having an oil holding capacity of 3-9 grams per gram (g/g).

33. Use of the canola protein concentrate of claim 15 or 21 in the production of a foam.

34. Use of the canola protein concentrate of claim 15 or 21 in the production of a gel.

35. Use of the canola protein concentrate of claim 15 or 21 in the production of an emulsion.

36. The use of claim 35, wherein the emulsion is an oil/water emulsion.

37. A foam comprising the canola protein concentrate of claim 15 or 21.

38. A gel comprising the canola protein concentrate of claim 15 or 21.

39. An emulsion comprising the canola protein concentrate of claim 15 or 21.

40. Use of the canola protein concentrate of claim 15 or 21 in a food or beverage application.

41. The use of claim 40, wherein the food or beverage application is selected from milk shake, protein bars, meat analogues, confectionary, condiments, mayonnaise, salad dressing, nutritional supplements and diary alternatives.

42. The use of claim 41, wherein the dairy alternative is selected from creamers, ice cream, yogurt, buttermilk and cheese.

43. A food or beverage comprising the canola seed protein concentrate of claim 15 or 21.
